(19) United States
(12) Patent Application Publication
(10) Pub. No.: US 2002/0132058 A1
(43) Pub. Date: Sep. 19, 2002

(54) Method for coating web

(75) Inventors: Yasuhiko Tokimasa, Minami-Ashigara-shi (JP); Yoshinobu Katagiri, Minami-Ashigara-shi (JP)

Correspondence Address: YOUNG & THOMPSON, 745 SOUTH 23RD STREET 2ND FLOOR, ARLINGTON, VA, 22202

(73) Assignee: FUJI PHOTO FILM CO. LTD., MINAMI-ASHIGARA-SHI (JP)

(21) Appl. No.: 10/050,585

(22) Filed: Jan. 18, 2002

(30) Foreign Application Priority Data
Jan. 18, 2001 (JP) 2001-010006

(51) Int. Cl. B05D 1/04

(52) U.S. Cl. 427/458

(57) ABSTRACT

An object of the invention is to provide a method to obtain and keep a uniform charge distribution on a web to be coated at the time of coating to establish stable high-speed coating. It was identified after some research that non-uniform charging is caused by not only non-uniformity at electrifying the web but also leakage of charge to transporting rollers from lateral edge area of the web while the web is transported contacting the rollers. An electrostatic charge on the electrified web leaks from one side surface when the one side contacts the roller and the amount of the leakage depends on a surface resistivity of the surface portion of web. If the leakage happens from a back surface (surface usually not to be coated), which causes leakage from a front surface area (surface to be coated) corresponding to the back surface area where the leakage happened. Thus it is understood that web of which back surface has higher resistivity in the edge area than that in the central area is useful for stable coating using electrified web. One of ways to provide higher surface resistivity to either both edge areas or one edge area is to apply a subbing layer to the web to leave the edge area unapplied.

### FIELD OF THE INVENTION

This invention relates to a method for coating various liquid coating solutions onto electrified webs for use in the manufacture of photographic film materials, photographic paper, photographic printing materials, magnetic recording materials such as magnetic recording tape, adhesive tape, information recording paper such as pressure-sensitive paper or thermal paper.

### BACKGROUND OF THE INVENTION

Methods for coating web are widely known where the surface of a web running continuously is electrified by some electrostatically charging devices to assist coating before a coating solution is applied, which is used in particular for realizing high-speed coating. In the coating using such electrified web, uniform charge distribution on the web is required. It is, however, not easy to give the charge-uniformity, specially in a lateral edge area of the web. Electrifying web by a corona-discharging does not give a sufficient charging on the web in the edge area, which causes the coating to be unstable in the area.

To avoid such non-uniformity of charging of the web, Japanese patent No. 2,747,837 shows a method using a combination of grounding web-transporting roller coated with ceramics by 0.3 to 0.5 mm thickness and corona-discharging electrode of which width is more than that of the web to extend it more than 10 mm in both sides. This method improves non-uniformity of charge for a moment, but still not enough at the time of coating. Japanese patent No. 2,835,659 presents another method where the web is electrified 0.5 to 2.0 KV in the surface potential after heated up to 35 to 45° C., but still non-uniformity remains in the edge area.

### SUMMARY OF THE INVENTION

An object of the invention is to provide a method to obtain and keep a uniform charge distribution on a web to be coated at the time of coating to establish stable high-speed coating.

It was identified after some research that non-uniform charging is caused by not only non-uniformity at electrifying the web but also leakage of charge to transporting rollers from lateral edge area of the web while the web is transported contacting the rollers. An electrostatic charge on the electrified web leaks from one side surface when the one side contacts the roller and the amount of the leakage depends on a surface resistivity of the surface portion of web. That is, the lower the resistivity of the surface is, the more the leakage from the surface becomes. If the leakage happens from a back surface (surface usually not to be coated), which causes leakage from a front surface area (surface to be coated) corresponding to the back surface area where the leakage happened when the front surface contacts roller next time.

Generally smaller surface resistivity is given to a back surface than to a front surface in order to avoid accumulation of electrostatic charge on the back surface which attracts various type of dust in the air. If some dusts are attracted to the web and transferred to the surface of coating roller (web backing roller at coating station), which causes coating defects and other defects. Thus relatively lower surface resistivity of the back surface leads to charge leakage from front surface, which tends to result in non-uniformity of charge on the front surface.

Based on the fact mentioned above, following methods are invented to accomplish the object. Method for coating web comprises steps of preparing a web of which at least one of both edge areas of the back surface has higher surface resistivity than a central area, advancing the web to pass by a coating station, electrifying the web upstream from the coating station; and coating the electrified web at the coating station. One of ways to provide the web of which at least one of both edge areas of the back surface has higher surface resistivity than the central area is to apply a subbing layer to the web so as to leave the edge area unapplied.

### BRIEF DESCRIPTION OF DRAWINGS

FIG. 1 shows a back surface of the web used in the invention.

FIG. 2A shows a sectional view of the web shown in FIG. 1.

FIG. 2B shows a sectional view of photographic film using the web shown in FIG. 1.

FIG. 3 shows another type of back surface of the web used in the invention.

FIG. 4A shows a sectional view of the web shown in FIG. 3.

FIG. 4B shows a sectional view of photographic film using the web shown in FIG. 3.

FIG. 5 is a schematic view illustrating a coating station including a curtain coater and electrostatic charging device used for the invention.

### DETAILED DESCRIPTION OF THE INVENTION EMBODIMENT

Supporting web:

In the invention, papers, plastic films, resin-coated papers and synthetic papers are used. As materials for the plastic films, polyolefines such as polyethylene or polypropylene, vinyl-polymers such as polyvinyl acetate, polyvinyl chloride or polystyrene, polyamide such as 6,6-nylon or 6-nylon, polyester such as polyethylene terephthalate or polyethylene-2, 6-naphthalate, polycarbonate or cellulose acetate such as cellulose triacetate or cellulose diacetate are used. Typical resin for the resin-coated paper is polyolef in. A gelatin layer is preferably used as a subbing layer on the web. Surface of the resin-coated paper can be a rough surface, not limited to a smooth one.

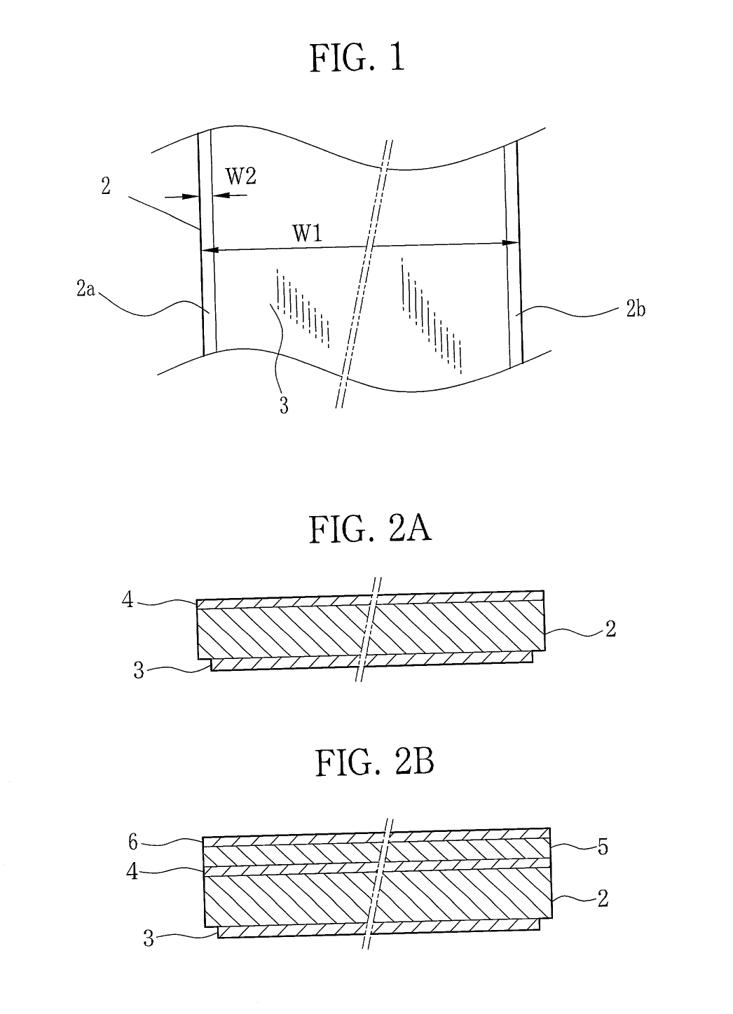

FIG. 1 shows a back surface of web used in the invention and FIG. 2 shows sectional views of the web. As shown in FIG. 1, back side of the web 2 has a subbing layer 3 of which width is narrower than the web width W1. Both elongated edge areas 2a and 2b of which widths are W2 respectively in the back side of the web 2 have no subbing layer. The back surface subbing layer 3 includes carboxyl group or carboxylic salt, hydrophilic polymer colloidal matter or inorganic colloidal matter, which gives lower surface resistivity than that of edge areas of the web without the subbing layer.

Material including carboxyl group is, for example, a solution formed by hydrolyzing copolymer of isobutylene and maleic anhydride with alkali such as sodium hydroxide or potassium hydroxide. Isobutylene could be replaced with 1-penten, butylvinylether or styrene. Other materials including carboxyl group are, for example, copolymer of styrene and itaconic acid, copolymer of styrene and crotonic acid or copolymer of methylacrylate and citraconic acid. Copolymer of those above-mentioned copolymers, or salt from those copolymers can also be used in this invention. Water-soluble polymer compounds including sulfone group are, for example, polystyrene sulfonic acid, polyvinyl benzilsulfonic acid or sodium or potassium salt of them. Carboxylic denatured polyethylene or salt thereof is an example of hydrophilic polymer colloidal matter. Colloidal alumina is a typical example of inorganic colloidal.

In case where the width W1 of web is between 1 and 5 m, the width W2 of each of elongated edge areas 2a and 2b where there is no subbing layer should be between 1 and 50 mm and more preferably between 1 and 30 mm. The back surface subbing layer can be formed by other methods than coating, such as lamination. Any materials can be used as the subbing layer as long as it can make surface resistivity lower than that of web itself (without the subbing layer). Thus the back surface subbing layer of which width is narrower than that of web 2 makes surface resistivity of edge areas 2a and 2b relatively higher (precisely resistivity of edge areas remains unchanged), which leads to lower leakage of charge from the edge areas. This improves uniformity of charge distribution on the web including edge areas and results in stable coating including the edge area.

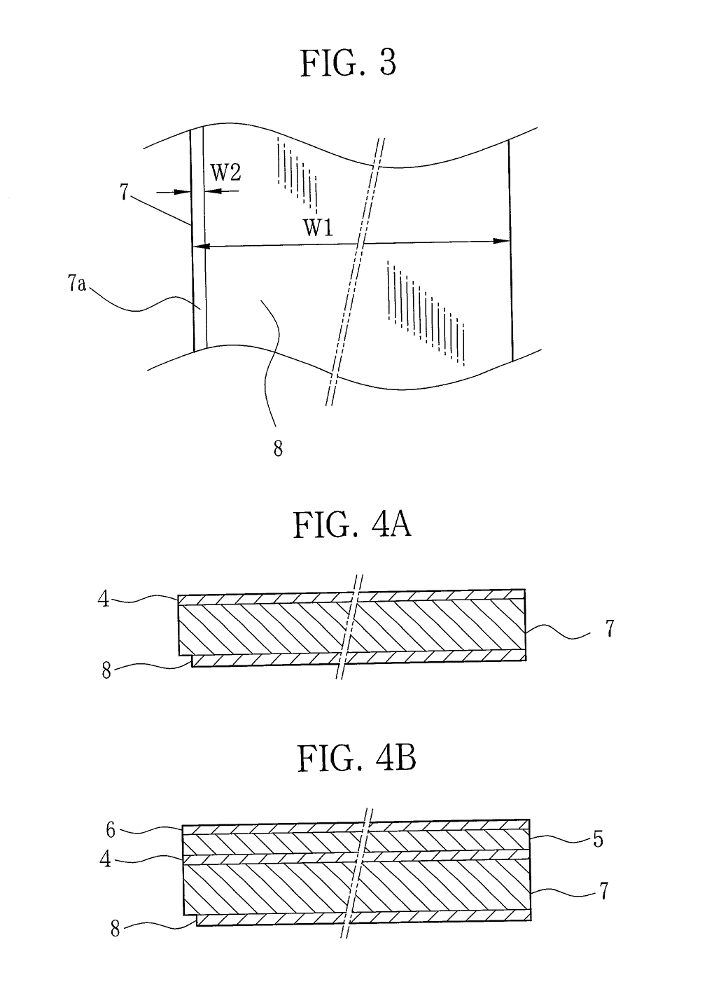

As shown in FIG. 2A, a subbing layer 4 including gelatin is previously formed on the front surface of web 2. A photographic layer 5 and a protective layer 6 shown in FIG. 2B are coated on the web 2 to form a photographic material. FIG. 3 shows a web 7 which is lack of a subbing layer 8 at only one side edge area 7a on the back surface. The front surface has a subbing layer 4 over the entire width. This type of supporting web is still capable of preventing the web from becoming non-uniform in distribution of charge caused by leakage thereof on the surface of web. As shown in FIG. 4A, a subbing layer 4 is previously formed on the front surface of web 7. A photographic layer 5 and a protective layer 6 shown in FIG. 2B are coated on the subbing layer 4 to form a photographic material.

Coating solution:

In the invention can be used a variety of coating solutions such as ones for a photographic emulsion layer, a subbing layer, a protective layer and a back layer for manufacturing photographic materials. Also coating solutions for an adhesive layer, dying layer or antirust layer can be used. Those coating solutions include water-soluble binder or organic binder.

Coating process:

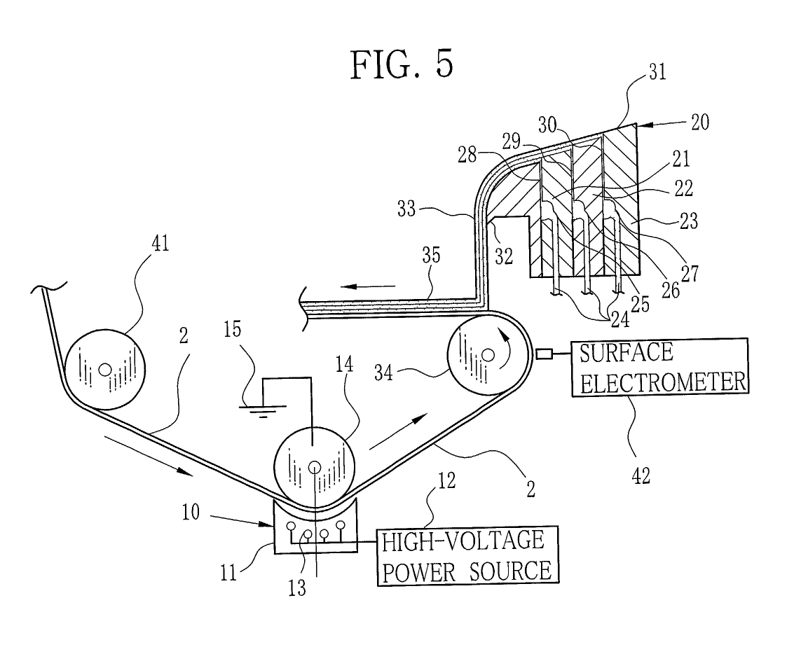

As shown in FIG. 5, surface of a web 2 is coated by a curtain coater 20 after being electrified by an electrostatic charging device 10. The electrostatic charging device 10 includes an electrode supporting frame 11, a high-voltage power source 12, a corona discharging electrode 13 and web transporting roller 14. The roller 14 is grounded by a grounding wire 15. After electrified, the web is coated by a curtain coater 20. The curtain coater used in this embodiment is so-called multiple slide hopper. The multiple slide hopper 20 is constituted by a plurality of die blocks 21, 22, 23 and block with lip edge 32 which are secured to each other. The multiple slide hopper 20 has slide surface 31 on its top side downwardly inclined, over which coating liquid flows by gravity.

In the multiple slide hopper 20, the first coating liquid 24a is continuously pumped through a feeding tube at a given rate into a cavity 25 from which the liquid is extruded through a narrow vertical slot 28 out onto the downwardly inclined slide surface 21. The cavity 25 and the slot 28 extend across the width of the hopper 20 to cause the coating liquid 24a pumped into the cavity 25 to spread out across the hopper 20 and to be forced through the narrow vertical slot 28 in the form of a ribbon of hopper width. Other slots 29 and 30, and cavities 26 and 27 of the multiple slide hopper 20 have the same structure and function. Second coating liquid 24b is fed into cavity 26 and third coating liquid 24c is fed into a cavity 27. The second coating liquid 24b is superimposed on the first coating liquid 24a while flowing down the inclined slide surface and likewise the third coating liquid 24c is superimposed on the second coating liquid 24b. Those superimposed layers flow down without mixing with each other and form a free-falling curtain 33 after leaving the lip edge 32 which impinges on the running web 2 backed by the backing roller 34 to form coated layer 35.

Surface potential of the front surface (to be coated) of the web is measured by a surface electrometer 42 while the web is backed by the roller 34. Curtain coating is used in this embodiment, however, the invention is applicable to other types of coating such as roller bead coating, slide bead coating, extrusion coating or spray coating.

### EXAMPLE

A polyethylene resin coated paper of 220μm thickness was used as web. Coating side (front side) of the web has a gelatin subbing layer of which dry thickness is 0.06 μm. Back surface of the web except edge areas is covered with a back surface subbing layer including inorganic anti-static agent. Width W2 of each edge area 2a, 2b was 5 mm respectively. This web was sample 1. Web of sample 2 has a full width subbing layer on the back. A surface resistivity of subbing layer was 10⁹Ω and that of web without subbing layer (in edge area) was 10¹⁶Ω.

Coating test was carried out by simultaneous three-layer coating. Coating solution for lowermost layer was made of 10 weight % aqueous solution of alkali treated gelatin, 0.15 weight % aqueous solution of sodium dodecylbenzenesulfonate and some amount of sodium polystyrenesulfonate to increase viscosity up to 40 cp. Coating solution for intermediate layer was made of 10 weight % aqueous solution of alkali treated gelatin, 0.05 weight % aqueous solution of sodium dodecylbenzenesulfonate and some amount of sodium polystyrenesulfonate to increase viscosity up to 70 cp. Coating solution for uppermost layer was made of 10 weight % aqueous solution of alkali treated gelatin, 0.15 weight % aqueous solution of sodium dodecylbenzenesulfonate and some amount of sodium polystyrenesulfonate to increase viscosity up to 20 cp.

Sample 1 web ran at a speed of 400 m/min. Initially voltage of 7.5 kV was applied to electrodes of a charging device 10 to form unipolar charge on the web, then the applied voltage was gradually reduced to determine lower limit of voltage to keep stable coating that edge areas of the web can be normally coated. The charging device 10 was connected to a DC constant-voltage power source Model664 made by TREK, INC.. Then simultaneous three-layer coating was carried out by using curtain coater 20. Each flow rate of three layers through the slot of multi-coating hopper of the curtain coater 20 is 1.25 cc/cm·s for the lowermost layer, 2.5 cc/cm·s for the intermediate layer and 1.25 cc/cm·s. Between the backing roller 34 and the charging device 10 are five web transporting rollers (not shown) contacting the front surface (to be coated) of the web and one web transporting roller (not shown) contacting the back surface. Sample 2 web was also tested in the same manner as for sample 1.

In an examination of the sample 1, the voltage of the charge device is gradually decreased in order to know the largeness of a limit voltage under which stable coating is difficult. The limit voltage of the sample 1 was 5.5 kV. The sample 2 is examined in the same way as the sample 1. The limit voltage of the sample 2 was 5.6 kV. This shows that sample 2 web requires slightly higher voltage to obtain same level of coating stability than sample 1 web.

In the same tests, surface potential of each web was also measured under the condition that voltage of 7 kV was applied to the electrodes to make corona discharge. Surface potentials of the edge area ( at a point 1 cm away from the edge of web) and of the center area of the web were measured by surface electrometer(electrostatic voltmeter), Model 334 made by TREK, INC.. The reason 7 kV was selected is that 7 kV is sufficient value to keep stable coating against disturbance such as passing of a spliced portion of a continuous web, although 5-6 kV was a limit value to maintain a stable coating.

TABLE 1 shows the surface potentials of each of samples 1 and 2.

TABLE 1

| | Edge area | Central area |
|---|---|---|
| | potential | potential |
| Sample 1 | 1500 V | 1800 V |
| Sample 2 | 1200 V | 1800 V |

Edge area potential of sample 1 is higher than that of sample 2, which indicates charge leakage from edge area in sample 1 is lower than that in sample 2. In other words, sample 1 has less non-uniform distribution of charge than sample 2. Thus it is understood that web of which back surface has higher resistivity in the edge area than that in the central area is useful for stable coating using electrified web. One of easy ways to provide higher surface resistivity to either both edge areas or one edge area is to apply a subbing layer to the web to leave the edge area unapplied.

It is to be understood that the above-described embodiments are simply of the invention. Other embodiments may be devised by those skilled in the art which will embody the principal of the invention and fall whithin the sprit and scope thereof.

What we claim is:

1. A method for coating web comprising the steps of:
(a) preparing a web of which one edge area or both edge areas of a back surface has higher surface resistivity than a central area of said back surface, said central area being among said both area;
(b) advancing said web to pass by a coating station;
(c) electrifying said web upstream from said coating station; and
(d) coating said electrified web at said coating station.

2. A method according to claim 1, wherein said web of which said edge area of said back surface has higher surface resistivity than said central area is prepared by applying a subbing layer to said web so as to leave said edge area unapplied.

3. A method according to claim 1, wherein a curtain coating is used for coating said electrified web at said coating station.

4. A method according to claim 1, wherein a surface voltage of said central area of said back surface is more than 1800 V.

5. A method according to claim 1, wherein surface resistivity of said edge area is 10¹⁶Ω.

6. A method according to claim 1, wherein width of said edge area having higher surface resistivity is between 1 and 50 mm.
